(19) United States
(12) Patent Application Publication
(10) Pub. No.: US 2019/0263439 A1
(43) Pub. Date: Aug. 29, 2019

(54) STEERING WHEEL HAVING OPERATOR CONTROL ELEMENTS, AND METHOD FOR SETTING A FUNCTION FOR A VEHICLE

(71) Applicant: DAIMLER AG, Stuttgart (DE)

(72) Inventors: Marc PRAMSOLER, Stuttgart (DE); Jens CIERULLIES, Deckenpfronn (DE); Volker HELLWIG, Stuttgart (DE)

(21) Appl. No.: 16/308,265

(22) PCT Filed: May 9, 2017
(86) PCT No.: PCT/EP2017/000566

§ 371 Date: Dec. 7, 2018

(30) Foreign Application Priority Data
Jun. 8, 2016 (DE) 102016007024.2

(51) Int. Cl. B62D 1/04; B60K 35/00; G06F 3/0362; G06F 3/02; G06F 3/041; G06F 3/0482; G06F 3/0488

(52) U.S. Cl. CPC B62D 1/046; B60K 35/00; G06F 3/0362; G06F 3/0202; B60K 2370/143; G06F 3/0482; G06F 3/04883; B60K 2370/782; B60K 2370/12; G06F 3/041

(57) ABSTRACT

A steering wheel for a motor vehicle includes first and second operator control elements. The first operator control element is for selecting a main function from amongst at least two main function alternatives using an integrated first display for displaying the main function alternatives comprising a first operating device for cycling through the main function alternatives displayed on the first display. The second operator control element is for selecting a subfunction from amongst at least two subfunction alternatives using an integrated second display for displaying the subfunction alternatives comprising a second operating device for cycling through or changing the subfunction alternatives which can be displayed on the second display. The subfunction alternatives selectable by the second operator control element and displayable by the second display are prespecified depending on the main function selected using the first operator control element.

### BACKGROUND AND SUMMARY OF THE INVENTION

Exemplary embodiments of the invention relate to a steering wheel for a motor vehicle, in particular a steering wheel for a motor vehicle comprising a first and a second control element, and to a method for setting a function using a steering wheel comprising a first and a second control element.

In modern passenger cars, there is often a wide selection of functions available that go beyond mere vehicle guidance. In addition to control options for vehicle ventilation, air conditioning and an entertainment system, adjustable parameters of the vehicle that relate to the driving behavior are also included in user options. For example, adaptive chassis can thus be set by the driver of the vehicle. An increasing number of adjustable functions of this kind means that there are correspondingly high demands on the design of the human-machine interface.

German patent document DE 10 2004 010 310 A1 discloses a rotatable control element comprising at least one integrated display element and at least one control function. In the document, the control element has at least one integrated display element and at least one control function, it being possible to freely program the at least one display element.

The problem addressed by the invention is improving the usability in the control of a plurality of functions of a vehicle.

A first aspect of the invention relates to a steering wheel for a motor vehicle, comprising:
a first control element having a first display for displaying a main function alternative from at least two main function alternatives and comprising a first operating device for cycling through the main function alternatives displayed on the first display, and
a second control element having a second display for displaying a subfunction alternative from at least two subfunction alternatives and comprising a second operating device for cycling through the subfunction alternatives that can be displayed on the second display, the subfunction alternatives that can be selected by the second control element and displayed by the second display being prespecified depending on the main function alternative that is displayed and confirmed by means of the first display, wherein,
by operating the first operating device, the first display switches from a currently displayed main function alternative to display of the next main function alternative and the displayed main function alternative is then considered to be selected and confirmed without additional user action.

A main or subfunction alternative is selected by operating the first or second operating device and is thus displayed on the first or second display. The mere selection of a main or subfunction alternative does not usually require confirmation, i.e., activation, of the function, but rather requires operation of an additional operating device. At the same time, a control element can advantageously be set up such that the function is already confirmed, i.e., activated, when an operating device is selected.

The vehicle may be a passenger car, truck, bus, rail vehicle, watercraft (for example ship), underwater vehicle or aircraft.

The term display is understood to mean any type of screen, as well as any backlit transparent surface. The first and the second displays are in particular screens, which are preferably equipped with LCD or LED elements. Alternatively, OLED displays are used. Color displays are further preferably used. These are screens are designed to show colored symbols and images, in particular by additive color mixing of the primary colors red, green and blue. The first and second displays are preferably integrated in the first and second control element, respectively. The first display, or the second display, or the first and the second display, is further preferably a touch-sensitive screen, also known as a touchscreen. In this preferred embodiment, the displays themselves are configured to collect an input from a user and to forward this to an arithmetic-logic unit. The first operating device or the second operating device are herewith combined in one component with the first or second display, respectively.

The term “operating device” describes an interface that transmits user input to an arithmetic-logic unit of the vehicle. The operating device is configured to show one or more of the main function or subfunction alternatives in a cycling-through display. In other words, by operating the first operating device, one main function alternative from all the main function alternatives that is currently displayed on the first display is switched directly to display of the next main function alternative, and operating the second operating device causes the subfunction alternative displayed on the second display to switch to the next. These modes are displayed one at a time on the first or second display when cycling through the display. The main function and subfunction alternatives displayed on the first and/or second display take effect immediately; in an alternative embodiment, the displayed main function and/or subfunction alternatives are to be confirmed by a user, i.e., the main function alternative takes effect immediately and a subfunction alternative is to be confirmed by a user, for example.

A subfunction alternative describes a variable dependent on a main function or a parameter of the main function. The subfunction alternative herewith comprises a subfunction assigned to a main function alternative or an adjustable function variable assigned to a main function alternative.

A main function alternative is understood to be a category, and then the elements assigned to the corresponding category act as the subfunction alternative. In particular, a value of the main function can be quantitatively determined by means of a subfunction of the subfunction alternatives.

In a preferred embodiment, a “sport mode” and a “comfort mode” are main function alternatives. In these cases, the main functions cause displays corresponding to the “comfort program” and “sport program” to be displayed in the subfunction alternatives. In particular, this concerns the subfunction alternative “chassis hardness” and subfunctions regarding adjustable parameters of a stability system (ESP system) of the vehicle. Furthermore, in particular, subfunction alternatives relating to setting an ESP control threshold, a position of an exhaust flap and adjustable sound systems of the vehicle are assigned to particular main function alternatives.

It is an advantageous effect of the invention that a driver of a vehicle can control key functions of the vehicle without taking his/her hands off the steering wheel of the vehicle, and in particular that, to control the functions, the hands of the driver must be on the steering wheel in order to be able to reach the corresponding control elements. The two aspects are used to increase both comfort and safety, because the eye needs to be drawn only to the steering wheel and not to a console when switching.

In an advantageous embodiment, the second control element comprises a third operating device for confirming the subfunction alternative displayed on the second display and/or the first control element comprises a fourth operating device for confirming the main function alternative displayed on the first display. In an embodiment, the main function alternative displayed on the first display can be confirmed by operating a fourth operating device of the first control element. Similarly, in another alternative or additional embodiment, a subfunction alternative displayed on the second display is confirmed by operating the third operating device of the second control element. Separate confirmation advantageously mitigates the risk of incorrect operation. The fourth or third operating device is preferably integrated in a first or second display configured as a touch display.

The first, second, third and/or fourth operating device and the first and second display are advantageously arranged on a side of the steering wheel facing the driver. Since the operating elements are in the driver's field of vision, a driver can accurately reach and control the operating element; simultaneously, a change in the main function and/or subfunction alternatives triggered by the operation can be directly read off the displays.

According to an advantageous embodiment, the first or second display is designed to show pictograms for symbolizing the main function alternatives or subfunction alternatives.

The term “pictogram” describes a symbol (also referred to as “icon” in the context of a representation of links, objects or executable programs on screens) that reproduces information by means of a particular significance of its shapes and colors. According to the content shown, a function or information is assigned to each pictogram. The purpose of a pictogram is that of communicating information, in particular visual information, to a user by means of a corresponding association. The information or functions shown each relate to one or more of the main function or subfunction alternatives. An advantage of this embodiment consists in the rapid and intuitive information transmission from the first or second control element to a user, without the information transmission requiring the user to undertake more complex interpretations.

According to another advantageous embodiment, the first control element or the second control element is designed as a rotary actuator, the first operating device or the second operating device constituting the rotary function thereof.

In the embodiment, the first control element or the second control element is a rotary actuator, in particular a rotary switch. The first operating device here constitutes the rotary function, i.e., the rotatable element, of the first control element and the second operating device constitutes the rotary function, i.e., the rotatable element, of the second control element. The rotary switch is preferably designed as a wheel, the outer edge of which is formed by a solid material, for example aluminum, and the inner circular area of which is enclosed by the outer circle, the inner circular area in particular being integrated in the first or second display. An advantage of this integrated arrangement is the intuitive operation for a user, who can automatically glance at the position of his/her hand controlling the rotary actuator to view the current selection of the at least two main function alternatives. In an advantageous embodiment, in response to the rotation of the rotary actuator on the first or second operating device, the main function or subfunction alternative displayed on the first or second display is immediately modified, and the displayed main function or subfunction alternative is then considered to be selected and confirmed without further user action.

According to another advantageous embodiment, the rotary actuator has a press function, which is constituted by the fourth operating device of the first control element or the third operating device of the second control element.

A user here preferably rotates the rotary actuator until the desired main function alternative or subfunction alternative is displayed on the first or second display. The user then selects the displayed main function alternative or the subfunction alternative by pressing the rotary actuator, i.e., by pressing the fourth or third operating device, in particular by pressing towards the axis of rotation used when rotating the rotary actuator, the term “pressing” being understood to mean an exertion of force, including touch, directed away from the user's body. The fourth or third operating device can be configured as a conventional switch, push-button or as a touch-controllable switch. The touch-controllable switch is here preferably combined with one of the displays as a touch display.

The user preferably selects the main function alternative on the rotary actuator of the first control element by rotating the first operating device and confirms the main function alternative by pressing on the fourth control element. In this case, a subfunction alternative assigned to the main function alternative is further selected by the user on the second control element by rotating the second operating device and is confirmed by operating the third operating device of the second control element. An advantageous effect of this embodiment can be found in the unique and conscious selection by a user of a function among the main function alternatives or the subfunction alternatives.

According to another advantageous embodiment, the first or second control element comprises at least one first push-button as the first or the second operating device.

In this case, the first operating device is provided on the first control element as the first push-button for selection from the associated main function alternatives. In this preferred embodiment, the first control element only has the first operating device and thus only one push-button. By operating the first operating device, main function alternatives are cycled through and selected, and this causes a subfunction alternative to be displayed on the second display of the second control element. On the second control element, the second operating device is configured as the first push-button, the operation of which causes the subfunction alternative displayed on the second display to be cycled through. In an embodiment, the main function or subfunction alternative displayed on the first or second display is also activated by the selection.

In a preferred embodiment, the first or second control element comprises a second push-button as a fourth operating device or as the third operating device. In this embodiment, the main function or subfunction alternative selected by the first push-button of the first or second operating device is to be confirmed by a user. The confirmation is carried out on the first control element by the fourth operating device and on the second control element by the third operating device. Additional user confirmation mitigates the risk of malfunctions. For example, on the second control element, the second operating device is configured as the first push-button and the third operating device is configured as the second push-button. On the second operating device, the subfunction alternative displayed on the second display is cycled through or modified by the first push-button; the selected subfunction alternative can be confirmed by means of the second push-button using the third operating device.

The term “push-button” describes a switch or a button which, upon operation, alternates between at least two discrete states, or provides at least one command for switching between two discrete states to an additional arithmetic-logic unit. It is possible to configure the push-buttons as a conventional switch, as a toggle or rocker switch or as a touch-controllable touch display.

According to another advantageous embodiment, the at least one second push-button is arranged next to the at least one first push-button. By means of the first push-button, incrementally adjustable subfunction alternatives are displayed on the second display and the alternatives can be confirmed by means of the second push-button arranged next to the first push-button. The term “subfunctions” is understood to mean functions or function variables. The at least one first push-button is preferably configured as a toggle switch or as a touch-controllable switch. Various main function or subfunction alternatives displayed on one of the displays can be cycled through or modified or various function values can be set by means of the first push-button and confirmed by means of the second push-button. In particular, a user increases a value of the subfunction alternative by the smallest possible modifiable value in each case by pressing on the first push-button. Further preferably, this value is continuously increased when a user holds the first push-button pressed down for a particular period of time after a threshold value. In particular, it is provided that a subfunction alternative whose parameters can be confirmed by the second push-button can be modified by means of the first push-button.

According to another advantageous embodiment, the second control element comprises two first push-buttons and one second push-button arranged next to each of the two first push-buttons. The display preferably comprises two display fields for displaying the subfunction alternatives that can be set by the second push-button. A user can advantageously keep an eye on a plurality of subfunction alternatives and can modify these by means of the first and second push-buttons.

According to another advantageous embodiment, the first or second push-button is configured as a touch-controllable switching element. The first or second push-button comprises a display on which an icon is displayed and by touching the icon a corresponding switching function is carried out. Alternatively, the touch-controllable switching element can be controlled by a swipe gesture, as a result of which various icons can be displayed and selected. The second push-button of the second operating device is preferably designed as a touch display; by touching an icon displayed on the touch display, a function or function variable selected by the second operating device is confirmed. The display and the switch thus form one unit. In an embodiment, the first control element can comprise a touch display, for example, which is set up by means of a swipe movement, for example, to select the main function alternatives. In an alternative embodiment, the first and second push-button can also be configured as a touch-controllable switching element.

A further aspect of the invention relates to a motor vehicle comprising a steering wheel as described above and in the following.

A further aspect of the invention relates to a method for setting a function by means of a steering wheel, comprising the following steps:
displaying, on the first display, a main function alternative from at least two main function alternatives;
cycling through all available main function alternatives and displaying the alternatives on the first display in response to operation of the first operating device;
displaying, on the second display, a subfunction alternative from at least two subfunction alternatives assigned to the displayed and confirmed main function alternative;
cycling through all available subfunction alternatives and displaying the alternatives on the second display in response to operation of the second operating device, wherein, by operating the first operating device, a main function alternative is switched to display of the next main function alternative and the displayed main function alternative is then considered to be selected and confirmed without additional user action.

In another embodiment, a subfunction alternative displayed on the second display is confirmed by operating the third operating device. With a confirmation, the function variable is output as a signal.

According to another advantageous embodiment, a main function alternative selected by means of the first operating device is displayed on the first display; the main function alternative displayed on the first display is confirmed by means of the fourth operating device. The associated subfunction alternatives are preferably displayed on the second display only after confirmation.

Advantages and preferred developments of the proposed method can be derived from analogous transfer of the statements made above in the context of the proposed device.

Additional advantages, features and details can be found in the following description, in which, where appropriate with reference to the drawings, at least one embodiment is described in detail. Identical, similar and/or functionally identical parts are provided with the same reference numerals.

### BRIEF DESCRIPTION OF THE DRAWING FIGURES

In the drawings:

FIG. 1 shows a vehicle having a steering wheel according to an embodiment of the invention;

FIG. 2 shows a first and a second control element on a steering wheel according to another embodiment of the invention;

FIG. 3 shows a steering wheel having a first and a second control element according to another embodiment of the invention; and

FIG. 4 shows a method for setting a function by means of a steering wheel according to another embodiment of the invention.

The views in the drawings are schematic and not to scale.

### DETAILED DESCRIPTION

FIG. 1 shows a vehicle 1 comprising a steering wheel 100. A first control element 10r and a second control element 101 are located on the steering wheel 100. On the control elements 10r, 101, operating devices are provided that allow a user to select a function of the vehicle 1.

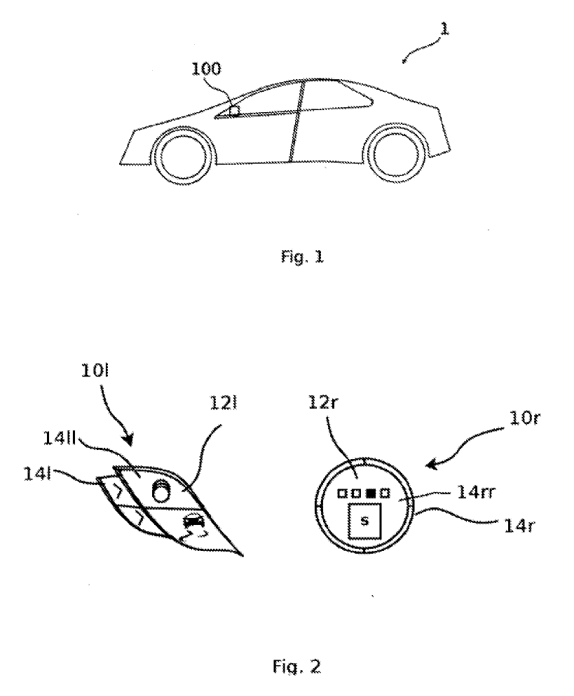

FIG. 2 shows a first control element 10r and a second control element 101, each having a first display 12r and a second display 121. The first control element 10r further comprises a first operating device 14r and a fourth operating device 14rr; the second control element 101 comprises a second operating device 141 and a third operating device 1411. The first operating device 14r is designed as a rotary switch and surrounds the first display 12r. By operating the rotary switch of the first operating device 14r, various main functions can be displayed on the first display 12r. Furthermore, the first control element 10r is equipped with a press function, the press function being constituted by a fourth operating device 14rr. By means of this press function, a main function from the main function alternatives is confirmed. The main function can also be considered to be already selected and confirmed by operation of the rotary switch and display on the first display 12r, such that a fourth operating device 14rr can be omitted in another embodiment. In particular, the rotary actuator has a variable adjustable resistor such that a user moves the rotary actuator initially by one detent by applying a force above a particular threshold value, a new main function from the main function alternatives being displayed on the first display 12r by rotating about a functionally associated angle. Furthermore, the third operating device 1411 is provided for confirming the subfunction alternative, or function variable of the subfunction alternative, displayed on the second display 121, and the second operating device 141 is provided for cycling through the subfunction alternative displayed on the second display 121 or for setting a function variable of the subfunction alternatives.

The second operating device 141 comprises two toggle push-buttons via which a user can modify subfunction alternatives, i.e., a function or a function variable, displayed on the second display 121. The second display 121 comprises two display fields for displaying the subfunction alternative selected by the two toggle push-buttons.

These functions or function variables, displayed as an icon, are shown in corresponding display fields in a cycling-through display on the second display 121 configured as a touchscreen. The second display 121 is thus simultaneously configured as the third operating device 1411, the selected subfunction alternatives or selected function variables being confirmed by operating the third operating device 1411, i.e., by touching the push-button configured as the touchscreen 121 on the corresponding display fields. In an alternative embodiment, it is also possible for just one toggle push-button and one display 121 having a display field to be provided.

According to a preferred embodiment, a sport mode and a comfort mode are the main functions or some thereof, the sport mode preferably being shown on the first display 12r in a pictogram by the symbol “S”. In addition, the first display 12r displays, for the purpose of orientation in the function menu, how many selection options of main function alternatives are available and which main function the current selection displays. In the figure, the third of four possible main functions is accordingly displayed. Further preferably, the display of the sport mode on the first display 12r is followed by the displays of the subfunctions on the second display 121, in particular the subfunction “chassis hardness,” the pictogram of which in the figure is shown in the upper half as a spring, and in particular the subfunction “ESP control threshold,” the pictogram of which is shown in the figure in the lower half of the second display 121 as a vehicle with skid marks. Similarly, the main function “comfort program” displayed on the first display 12r causes the subfunctions “exhaust flap adjustment” and “sound” to be displayed on the second display 121.

In an alternative embodiment, the second operating device 141 can be provided for confirming the displayed subfunction alternative or function variable of the subfunction alternative, and the third operating device 1411 can be provided for the cycling-through display of the subfunction alternatives or for setting the function variable. Accordingly, via the third operating device 1411, which is designed in particular as a touchscreen 121, the display is switched between two subfunctions or a function variable is set and, via the rocker push-button of the second operating device 141, the subfunction or the function value is confirmed and activated.

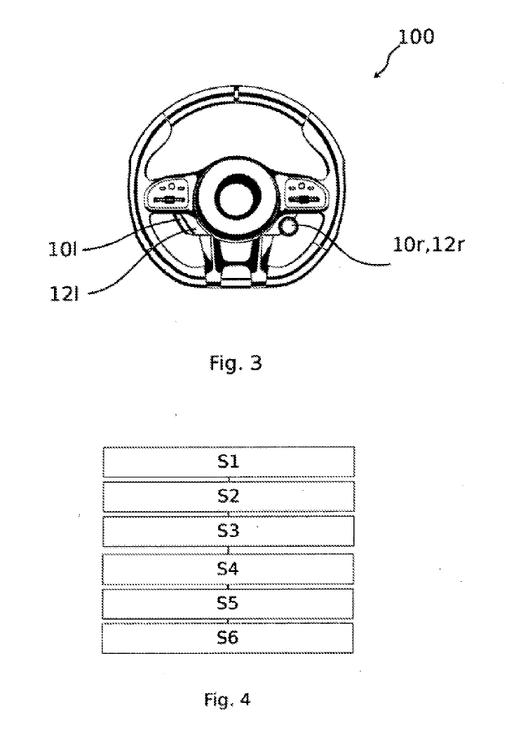

FIG. 3 shows a steering wheel 100 having a first control element 10r and a second control element 101. Here, the first control element 10r is arranged on a side of the steering wheel 100 that can usually be reached by the right hand of the driver without the driver needing to remove his hand completely from the outer frame of the steering wheel 100. In addition, the first operating device 14r of the first control element 10r is a rotary switch that can be reached by the thumb of the right hand of a driver and can thus be controlled from a position in which the driver has his/her right hand on the frame of the steering wheel 100. Similarly, the second control element 101 is arranged on the left-hand side of the steering wheel 100 such that a driver of the vehicle 1 can control the second operating device 141 and, where appropriate, the third operating device 1411 using the thumb of his left hand. A first display 12r is arranged on the first control element 10r such that the rotary switch of the first control element 10r encircles the first display 12r. In contrast, the second display 121 is arranged on the second control element 101.

FIG. 4 shows a method for setting a function by means of a steering wheel 100, comprising the following steps:
displaying S1, on the first display 12r, a main function alternative from at least two main function alternatives;
cycling through S2 all available main function alternatives and displaying the alternatives on the first display 12r in response to operation of the first operating device 14r;
displaying S3, on the second display 121, a subfunction alternative from at least two subfunction alternatives which are assigned to the displayed and confirmed main function alternative;
cycling through S4 all available subfunction alternatives and displaying S5 the alternatives on the second display 121 in response to operation of the second operating device 141, wherein,
by operating the first operating device, a main function alternative is switched to display of the next main function alternative and the displayed main function alternative is then considered to be selected and confirmed without additional user action.

In another embodiment, by means of the first operating device 14r, the main function alternatives displayed on the first display 12r are displayed in response to the operation of the first operating device 14r and, by means of a fourth operating device 14rr, the main function alternative displayed on the first display 12r is confirmed and the associated subfunction alternatives are displayed on the second display 121 only after confirmation.

Although the invention has been illustrated and explained in more detail by preferred embodiments, the invention is not limited by the disclosed examples, and a person skilled in the art may derive other variations therefrom without departing from the scope of the invention. It is therefore clear that there are many possible variations. It is likewise clear that embodiments mentioned by way of example are really only examples which are not to be understood to limit in any way the scope of protection, the possible applications or the design of the invention, for instance. Rather, the above description and the description of the figures enable a person skilled in the art to specifically implement the exemplary embodiments, it being possible for a person skilled in the art, in the knowledge of the disclosed concept of the invention, to make many and various modifications, for example with respect to the function or the arrangement of individual elements mentioned in an exemplary embodiment, without departing from the scope of the invention defined by the claims and the legal equivalent thereof, for instance further explanations in the description.

1-10. (canceled)

11. A steering wheel for a motor vehicle, comprising:
a first control element having a first display configured to display a main function alternative from at least two main function alternatives and comprising a first operating device configured to cycle through the at least two main function alternatives displayed on the first display; and
a second control element having a second display configured to display a subfunction alternative from at least two subfunction alternatives and comprising a second operating device configured to cycle through the at least two subfunction alternatives displayable on the second display,
wherein the at least two subfunction alternatives selectable by the second control element and displayable by the second display are prespecified depending on the main function alternative displayed and confirmed on the first display,
wherein by operating the first operating device, the first display switches from a currently displayed main function alternative to display of a next main function alternative and the displayed main function alternative is then selected and confirmed without additional user action.

12. The steering wheel of claim 10, wherein the second control element comprises a third operating device configured to confirm the subfunction alternative displayed on the second display.

13. The steering wheel of claim 12, wherein
the first control element or the second control element is a rotary actuator, and
the first operating device or the second operating device constitutes a rotary function of the rotary actuator.

14. The steering wheel of claim 13, wherein the rotary actuator has a press function constituted by the third operating device of the second control element.

15. The steering wheel of claim 10, wherein the second control element comprises at least one first push-button as the second operating device.

16. The steering wheel of claim 12, wherein the second control element comprises a second push-button as the third operating device.

17. The steering wheel of claim 16, wherein the at least one second push-button is arranged next to the at least one first push-button, actuation of the first push-button changes displays of incrementally adjustable subfunction alternatives on the second display and, one of the incrementally adjustable subfunction alternatives is confirmed by actuation of the second push-button arranged next to said first push-button.

18. The steering wheel of claim 17, wherein the second control element comprises two first push-buttons and one second push-button arranged next to each of the two first push-buttons.

19. The steering wheel of claim 16, wherein the first or the second push-button is a touch-controllable switching element.

20. A method for setting a function using a steering wheel comprising a first control element having a first display and a first operating device and a second control element having a second display and a second operating device, the method comprising:
displaying, on the first display, a main function alternative from at least two main function alternatives;
cycling through all available main function alternatives and displaying the available main function alternatives on the first display in response to operation of the first operating device;
displaying, on the second display, a subfunction alternative from at least two subfunction alternatives assigned to a displayed and confirmed main function alternative;
cycling through all available subfunction alternatives and displaying the available subfunction alternatives on the second display in response to operation of the second operating device,
wherein, by operating the first operating device, a main function alternative is switched to display of a next main function alternative and the displayed main function alternative is then selected and confirmed without additional user action.
